(19) United States
(12) Patent Application Publication
(10) Pub. No.: US 2026/0204019 A1
(43) Pub. Date: Jul. 16, 2026

(54) SYSTEM TO GENERATE ORDERED QUADRANGULAR MESHES AND A METHOD THEREOF

(71) Applicant: Alexandr Ardachkin, Mississauga (CA)

(72) Inventor: Alexandr Ardachkin, Mississauga (CA)

(21) Appl. No.: 19/015,630

(22) Filed: Jan. 10, 2025

(51) Int. Cl. G06T 17/20

(52) U.S. Cl. CPC G06T 17/20

(57) ABSTRACT

The system is designed to generate ordered quadrangular meshes for three-dimensional, non-canonical surfaces. It includes a partitioning unit that divides the input surface into quadrangular fragments. The system features a computational unit connected to the partitioning unit, which transforms each fragment into a topological square using form functions. A subdivision module, linked to the computational unit, assigns and applies different division numbers (n1, n2, n3, and n4) to each side of the square. This process results in various mesh forms, including square, rectangular, and quadrangular elements. The system further includes a mesh generation unit connected to the subdivision module, which constructs an ordered mesh composed of convex quadrangular elements. The generated mesh ensures that neighboring elements have comparable properties, and a triangular element is added if the sum of the division numbers is odd, ensuring consistency and structural integrity in the mesh.

### TECHNICAL FIELD

The present disclosure relates generally to generate geometric meshes. More particularly, the present disclosure relates to a system to generate ordered quadrangular meshes and a method thereof.

### BACKGROUND

Mesh generation is a critical process in various computational modelling applications, including computer graphics, finite and boundary element analysis, and scientific simulations. The accuracy and stability of these applications often depend on the quality of the underlying mesh structure. A fundamental approach widely used in this field involves the employment of triangular elements as the primary building blocks of meshes. Over the years, numerous algorithms have been developed to create two-dimensional and three-dimensional meshes using triangles as the basic elements. These algorithms have been refined over long periods, resulting in processes that are both stable and highly precise.

Despite the advancements and the many advantages offered by triangular mesh generation algorithms, a significant technical problem persists. Specifically, the triangular elements generated by these methods are typically not regular or quasi-regular, with only a few trivial exceptions. The irregularity of these triangular elements can lead to suboptimal performance in computational processes, as it affects the uniformity and quality of the mesh. This irregular arrangement can hinder the convergence and accuracy of numerical methods, impacting the efficiency of simulations and analyses.

The major disadvantage lies in the inherent disorganization of triangular elements within the mesh. This lack of order, except in a few trivial cases, poses challenges in ensuring consistency across the mesh and maintaining high computational performance. As a result, there is an ongoing need for improved methods that address these limitations by producing meshes that are more regular or quasi-regular while preserving the stability and precision necessary for high-quality computational modelling.

Thus, there is a need for a technical solution that overcomes the aforementioned problems of conventional event generators.

### SUMMARY

To address the aforementioned issues, the present invention provides a system and method that provides a technique that utilizes convex quadrangles as basic elements for mesh generation. This approach ensures that all elements in the mesh are well-ordered, overcoming the limitations of traditional triangular mesh generation methods.

The present invention introduces system and method for mesh generation that uses convex quadrangles as basic elements to create well-ordered, uniform meshes. Unlike traditional triangulation methods, where the elements are often irregular and require repeated adjustments to achieve comparability, this method ensures that neighbouring elements have comparable areas, configurations, and sizes from the outset. This uniformity enhances computational stability and accuracy, particularly for numerical methods like the Boundary Elements Method (BEM) and Finite Elements Method (FEM).

Key technical advantages include the ability to handle curved, non-canonical surfaces by breaking them into quadrangular fragments that are topologically transformed into a standardized format for precise meshing. The algorithm guarantees continuity at fragment junctions, supports high precision on 32-bit and 64-bit machines, and provides faster processing due to its intrinsic well-ordering property. These attributes result in more precise and stable solutions for complex computational tasks compared to traditional triangular mesh approaches.

The invention offers several key technical advantages:

Property of Comparability: The system and method ensure that neighboring elements in the mesh are comparable in terms of area, configuration, and size. This property, critical for numerical methods such as the Boundary Elements Method (BEM) and Finite Elements Method (FEM), typically requires additional steps when using triangular elements, often necessitating multiple iterations of mesh generation.

High Precision: The system and method achieve very high calculation precision, capable of reaching up to thirty significant digits on 32-bit machines without specialized algorithms. On 64-bit machines, the precision is practically unlimited, enhancing the accuracy of numerical analyses. Improved Results for BEM and FEM: When solving matrices of integral or differential equations, quadrangular elements provide more precise and stable results compared to triangular elements, contributing to better performance in computational models.

Increased Efficiency: The system and method inherently incorporate well-ordering, enabling it to operate faster than traditional triangulation methods that lack this built-in structure.

Geometric Intuitiveness: The method's approach is more intuitive and facilitates clearer visualization, making it easier to implement and analyze in various applications.

Technical Requirements Addressed by the Invention and solution provided:
Handling Non-Canonical Surfaces: The system and method can process curved, non-smooth surfaces by segmenting them into larger quadrangular fragments.
Transformation Using Form Functions: The system and method uses special form functions to map each quadrangular fragment into a topological square with equal side lengths, facilitating isoperimetric analysis.
Variable Division of Fragments: Each side of the quadrangular fragment can be divided into different numbers of parts (n1≠n2≠n3≠n4), accommodating complex surface geometries.
Comparable Neighboring Elements: Ensures that adjacent elements maintain similarity in area, configuration, and size, supporting consistency.
Continuity Across Fragment Conjunctions: Guarantees seamless continuity where fragments meet, preserving the integrity of the overall mesh.
Approximation Flexibility: Supports linear, quadratic, or cubic approximations to describe both individual fragments and the complete surface geometry more precisely.
Generation of Well-Ordered Meshes: Produces a structured, quadrangular mesh for each fragment, which can then be reconstructed to its global configuration.

Advantages Over Traditional/conventional methods: The system and method offers several advantages over traditional triangular mesh generation methods:
Enhanced Stability and Precision: The comparability and ordering of quadrangular elements ensure higher stability and precision.
Reduced Iterative Processes: Unlike traditional methods that may require multiple iterations to achieve comparability, the system and method achieves it inherently.
Superior Performance in Numerical Methods: Yields more accurate and stable solutions in BEM and FEM applications.
Faster Execution: The inclusion of well-ordering within the algorithm streamlines the process, making it more efficient.
Intuitive Geometric Handling: Easier to visualize and apply to complex surfaces.

By meeting these technical requirements and addressing the limitations of existing triangular-based methods, the system and method of the present invention represents a significant improvement in mesh generation for computational modeling.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a graphical representation of triangular elements that are generated by way of conventional algorithms;

FIG. 2 illustrates a block diagram of a system to generate ordered quadrangular meshes for three-dimensional, non-canonical surfaces, in accordance with an embodiment of the present disclosure;

FIGS. 3A-3G illustrates an exemplary geometry of a mesh generated by the system of FIG. 2, in accordance with an embodiment of the present disclosure;

FIGS. 4A-4B illustrate a first table that shows various values when the number of dividing is same in all sides and in opposite sides while generation of the mesh by the system of FIG. 2, in accordance with an embodiment of the present disclosure;

FIGS. 5A-5B illustrate a second table that shows information associated with the quadrangular mesh and triangular mesh that may be generated by the system of FIG. 2, in accordance with an embodiment of the present disclosure; and

FIG. 6 illustrates a flowchart of a method for generating two-or three-dimensional geometric meshes, in accordance with an embodiment of the present disclosure. To facilitate understanding, like reference numerals have been used, where possible, to designate like elements common to the figures.

### DETAILED DESCRIPTION

Various aspects of the present disclosure provide a system to generate ordered quadrangular meshes and a method thereof. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this disclosure. Rather, the inventor/inventors have contemplated that the claimed subject matter might also be embodied in other ways, to include different features or combinations of features similar to the ones described in this document, in conjunction with other technologies. Generally, the various aspects including the example aspects relate to a system to generate ordered quadrangular meshes and a method thereof.

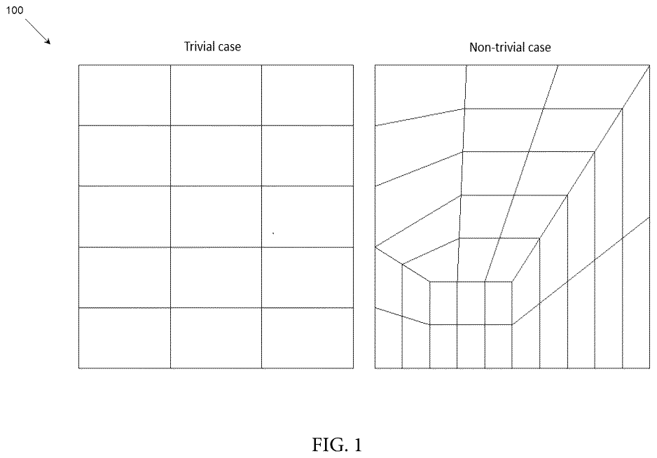

FIG. 1 illustrates a graphical representation 300 of triangular elements that facilitate generation of the mesh by the system 200, in accordance with an embodiment of the present disclosure. The techniques have been developed over the years for generating two-and three-dimensional meshes using triangles as the basic elements. The triangle meshes, despite having advantages, there are notable limitations. The triangular elements are generally not well-ordered, except in a few trivial cases, as illustrated in FIG. 1.

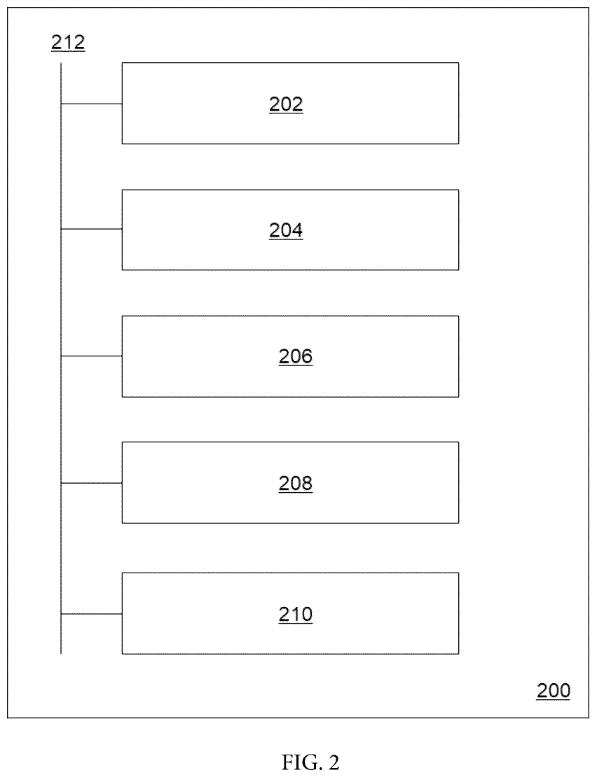

FIG. 2 illustrates a block diagram of a system 200 to generate ordered quadrangular meshes for three-dimensional, non-canonical surfaces, in accordance with an embodiment of the present disclosure. The system 200 may be configured to generate mesh for the complex structures. The system 200 may be employed in any application that uses geometrical meshes. For example, the applications that use Boundary Elements Method (BEM) technique or Finite Elements Method (FEM) technique. The system 200 may facilitate an application that may be used to create geometrical shapes. For example, the system 200 may be configured to prepare mesh for airplanes, cars, and space rockets. Embodiments of the present disclosure are intended to include and/or otherwise cover any type of the application where complex surfaces are involved and where mesh generation is required, without deviating from the scope of the present disclosure. The system 200 may be further configured to generate the mesh by considering one or more parameters of the surface. Specifically, the system 200 may be configured to generate the mesh by considering the body tensions associated with the surface for which the mesh may be generated. The system 200 may be configured to use or require encrypted geodetic maps when the system 200 is used in military applications. Specifically, the system 200 may facilitate safety of the data associated with the surfaces related to military applications. In most of the cases, triangulation may not give well-ordered mesh. In other words, in certain scenarios, the triangulation may not facilitate to generate regular meshes.

The system 200 may include a partitioning unit 202, a computational unit 204, a subdivision module 206, a mesh generation unit 208, and an output unit 210. The partitioning unit 202, the computational unit 204, the subdivision module 206, the mesh generation unit 208, and the output unit 210 may be communicatively coupled to each other. Specifically, the partitioning unit 202, the computational unit 204, the subdivision module 206, the mesh generation unit 208, and the output unit 210 may be communicatively coupled to each other through a communication channel 212. The communication channel 212 may facilitate exchange of information associated with the system 200 among the partitioning unit 202, the computational unit 204, the subdivision module 206, the mesh generation unit 208, and the output unit 210. The communication channel 212 may be one of, a wired communication channel and a wireless communication channel. The wireless communication channel may be realized by a Bluetooth technique.

The partitioning unit 202 may be configured to partition an input surface into a plurality of fragments. Specifically, the partitioning unit 202 may be configured to partition the input surface into the quadrangular fragments.

The computational unit 204 may be configured to transform each fragment of the quadrangular fragments. Specifically, the computational unit 204 may be configured to transform each fragment of the quadrangular fragments into topological square using form functions.

The subdivision module 206 may be configured to assign different numbers of divisions (n1, n2, n3, and n4). Specifically, the subdivision module 206 may be configured to assign and apply the different numbers of divisions (n1, n2, n3, and n4) to each side of the square, that results in various mesh forms. The mesh forms may include a square mesh form, a rectangular mesh form, and quadrangular elements.

The mesh generation unit 208 may be configured to construct the ordered mesh with convex quadrangular elements. The neighbouring elements may have comparable properties. The system 200 may be configured to add a triangular element when sum of the divisions is odd. The mesh generation unit 208 may employ a mesh generation technique that may facilitate construction of the ordered mesh as an integral part in the generation of the mesh. The mesh generation technique may employ linear, quadratic, or cubic approximations that may correspond to geometry of each mesh fragment and the entire mesh. The mesh generation unit 208 may be further configured to reconstruct each mesh fragment from the topological square to an original form. Specifically, the mesh generation unit 208 may be configured to reconstruct each mesh fragment from the topological square to the original form by way of reconversions of the form functions. The mesh generation unit 208 may be configured to generate the mesh that may guarantee that the resulting mesh has continuous junctions between adjacent fragments.

The output unit 210 may be configured to display the mesh that may be generated by the mesh generation unit 208. The output unit 210 may be one of, a screen, a display, a Light Emitting Diode (LED), a Liquid Crystalline Display (LCD), and the like. Embodiments of the present disclosure are intended to include and/or otherwise cover any type of the output unit 210, without deviating from the scope of the present disclosure. The mesh may be applicable to surfaces with varied smoothness. The surfaces may include one of, non-smooth surfaces and non-canonical surfaces. The output unit 210 may be configured to output the mesh with significantly higher calculation precision when used in 32-bit or 64-bit computational environments.

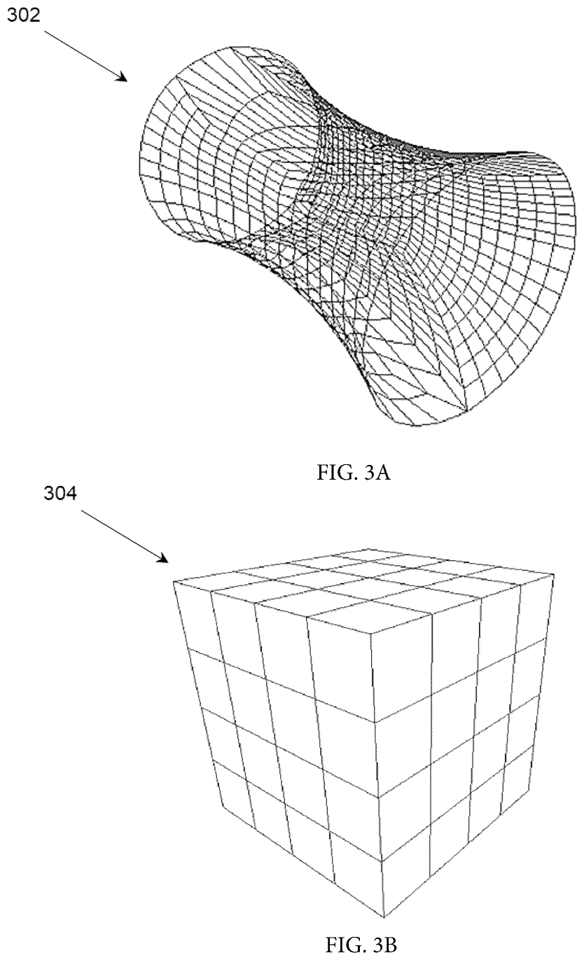

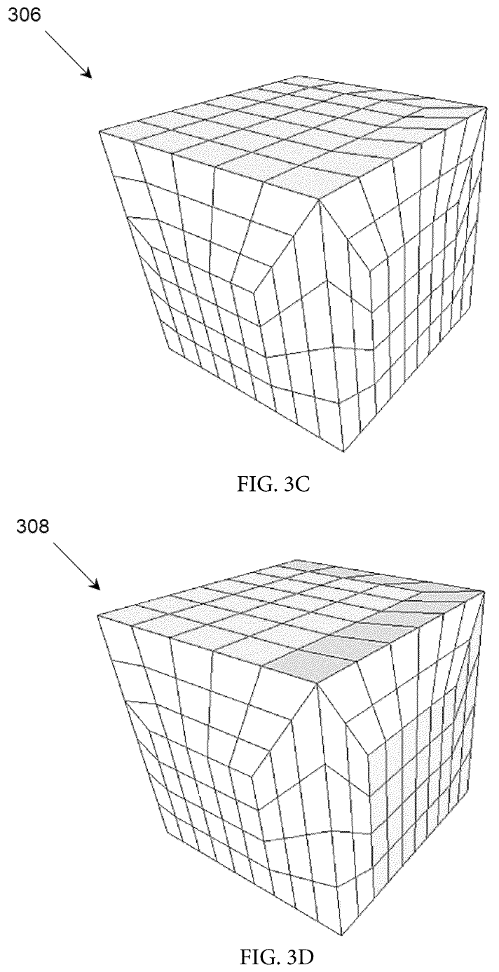

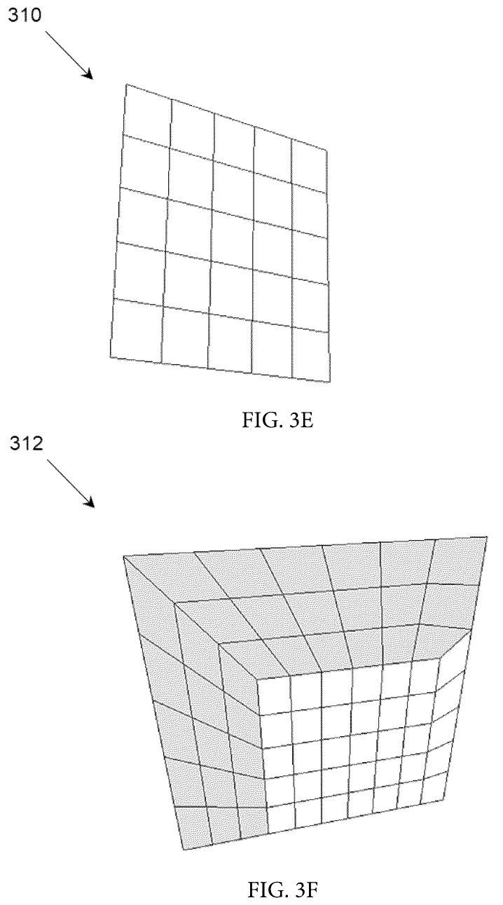

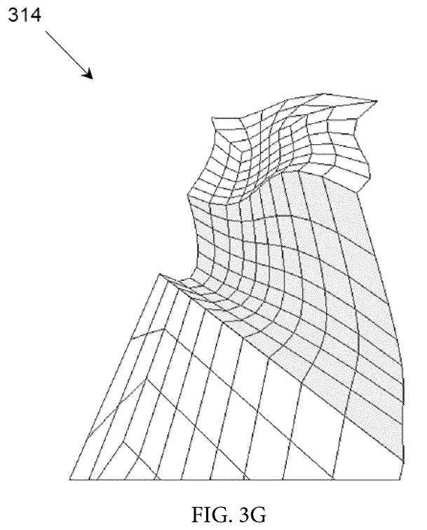

FIGS. 3A-3G illustrates an exemplary geometries of a mesh generated by the system 200 of FIG. 2, in accordance with an embodiment of the present disclosure. FIG. 3A illustrates a plank hyperboloid geometry 302 of the mesh that may be generated by the system 200. The system 200 may be configured to divide the surface into 4 fragments to generate the geometry of plank hyperboloid for the mesh. The system 200 may be further configured to recognize quadratic approximation for each fragment of the 4 fragments. The system 200 may be configured to facilitate each fragment to lead into topological square. The system 200 may be configured to generate a non-trivial mesh for each fragment. The system 200 may be configured to execute geometrical reconversion that may facilitate to generate the plank hyperboloid geometry 302 for the mesh.

FIG. 3B illustrates a cubical geometry 304 of the mesh that may be generated by the system 200. Specifically, FIG. 3B illustrates the cubical geometry 304 having same sides. FIG. 3C illustrates another cubical geometry 306 of the mesh that may be generated by the system 200. Specifically, FIG. 3C illustrates another cubical geometry 306 of the mesh that may have different dividing by sides. FIG. 3D illustrates another cubical geometry 308 of the mesh that may be generated by the system. Specifically, FIG. 3D illustrates another cubical geometry 308 of the mesh that may have a plurality of sub-regions such that each sub-region of the plurality of sub-regions may be formed at the sides of the cubical geometry 308.

FIG. 3E illustrates a linear geometry 310 of the mesh that may be generated by the system 200. Specifically, FIG. 3E illustrates the linear geometry 310 having a simple linear fragment. FIG. 3F illustrates another linear geometry 312 of the mesh that may be generated by the system 200. Specifically, FIG. 3F illustrates another linear geometry 312 of the mesh that may have linear fragment with different dividing by sides.

FIG. 3G illustrates another complicated geometry 314 of the mesh that may be generated by the system 200. Specifically, FIG. 3G illustrates the complicated geometry 314 of the mesh that may follow linear approximation, quadratic approximation, and cubical approximation.

The system 200 offers several advantages over traditional triangulation methods. One key benefit is the inherent comparability of neighbouring elements in the mesh. This means neighbouring elements are similar in terms of areas, configurations, and sizes, a critical property for numerical methods like the Boundary Element Method (BEM) and Finite Element Method (FEM). In traditional triangulation approaches, achieving this property often requires multiple iterations of mesh generation. Additionally, the system 200 boasts exceptional computational precision, achieving up to 30 significant digits on 32-bit systems and virtually unlimited precision on 64-bit systems, without the need for specialized calculations.

Moreover, the system 200 significantly improves the accuracy and stability of results for BEM and FEM calculations, as quadrangular elements are better suited for these applications than triangular ones. Its well-ordering feature, integrated directly into the system 200, also ensures faster processing compared to traditional methods. From a geometric perspective, this system 200 is more intuitive and visually acceptable, making it a practical and efficient choice for real-world applications.

The system 200 is designed to meet specific requirements for generating well-ordered meshes on curved, non-canonical surfaces. These surfaces are divided into large quadrangular fragments, which are then transformed into topological squares using isoperimetric concepts. Neighbouring elements are carefully designed to maintain comparability in terms of size and configuration, while ensuring continuity at the fragments'junctions. Although this document focuses primarily on covering a topological square with well-ordered convex quadrangular elements, steps involving advanced approximations and reconversions are not detailed here for the sake of brevity.

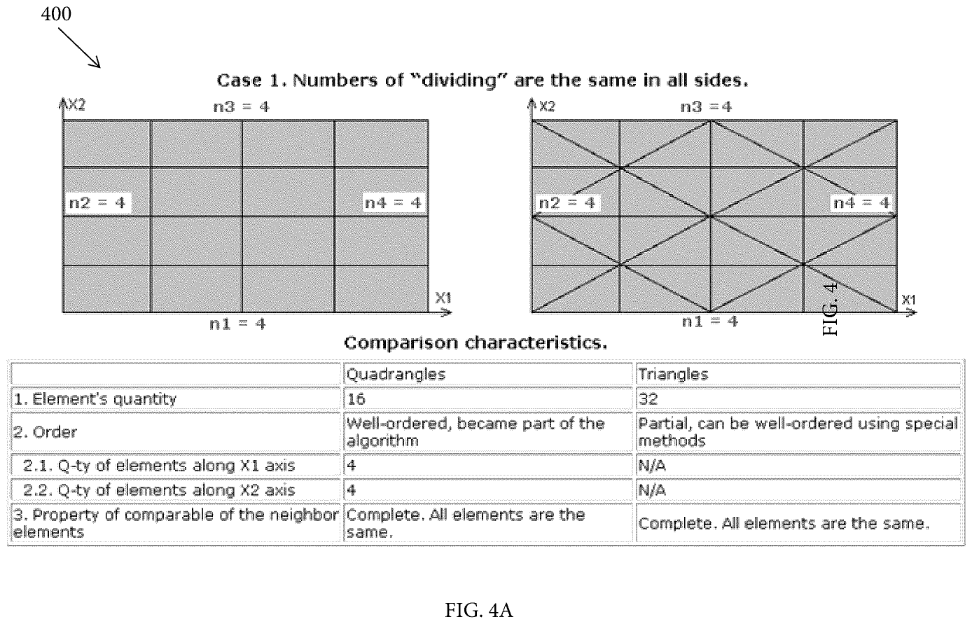

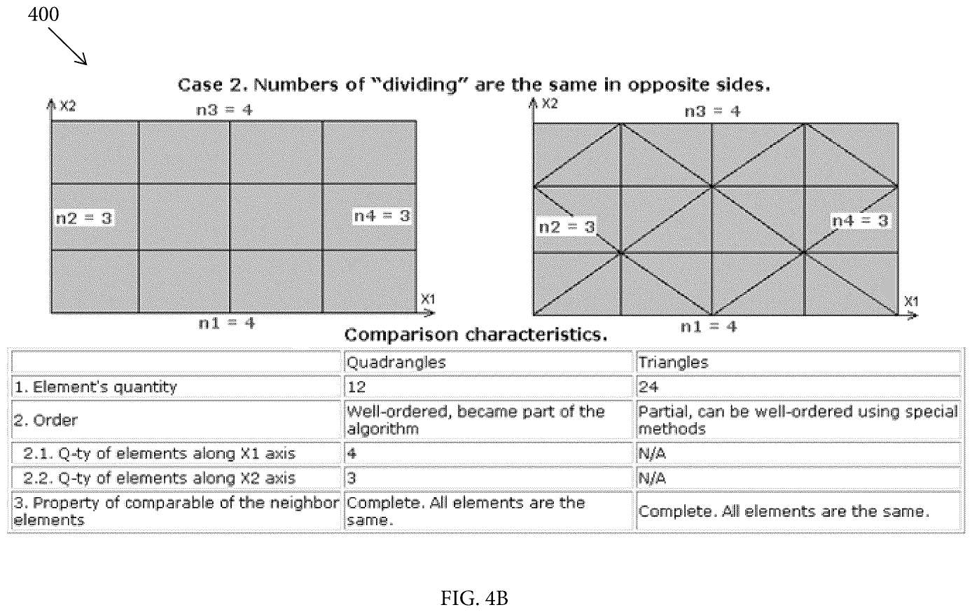

FIGS. 4A-4B illustrate a first table 400 that shows various values when the number of dividing is same in all sides and in opposite sides while generation of the mesh by the system 200 of FIG. 2, in accordance with an embodiment of the present disclosure.

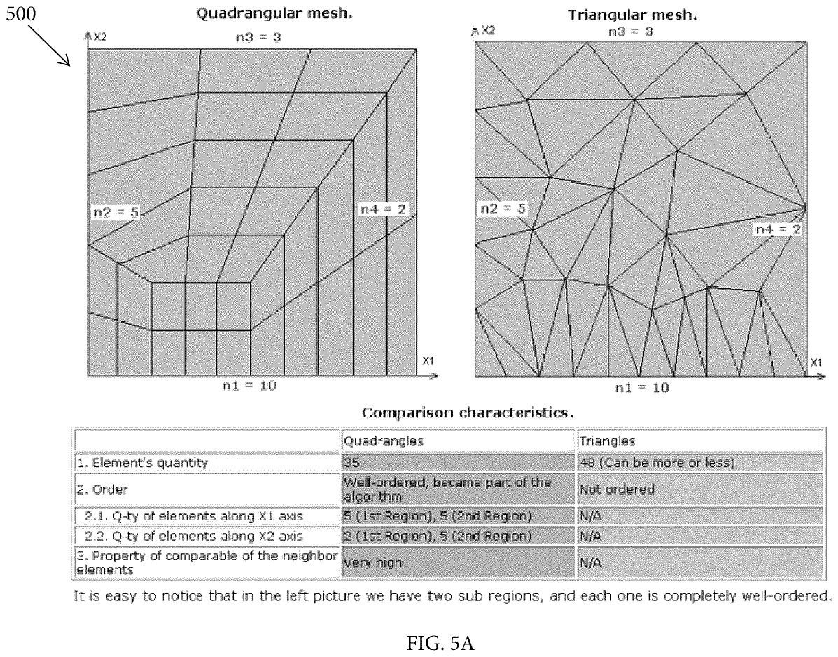

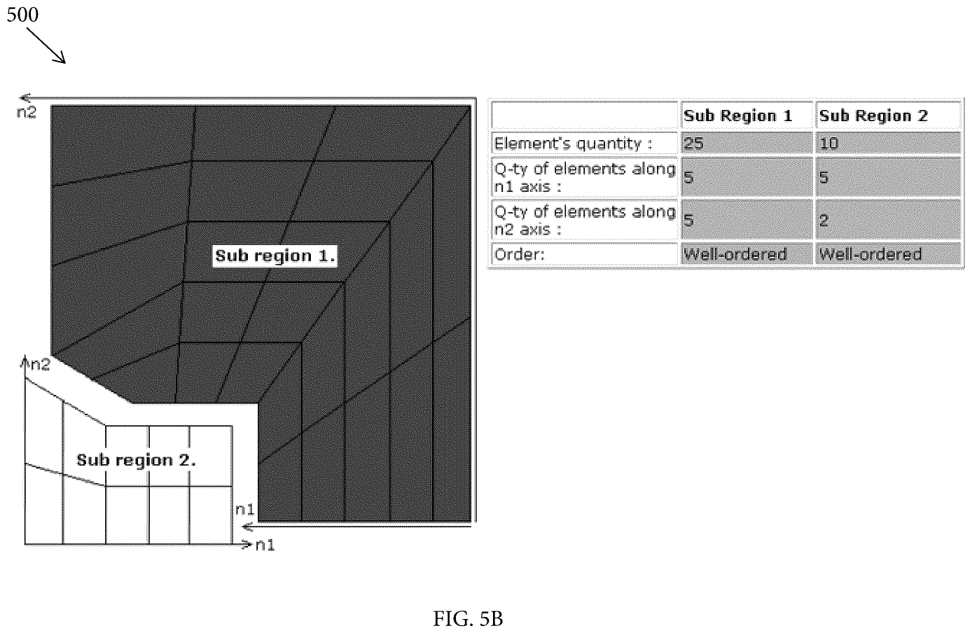

FIGS. 5A-5B illustrate a second table 500 that shows information associated with the quadrangular mesh and triangular mesh that may be generated by the system 200 of FIG. 2, in accordance with an embodiment of the present disclosure. Specifically, FIGS. 5A-5B show the second table when the number of dividing is different in all sides. For example, n1=10, n2=5, n3=3, and n4=2 as shown in FIGS. 5A-5B. the system 2 pertains to a geometric mesh system that uses quadrangular elements as its fundamental building blocks. It introduces a method for generating a mesh on three-dimensional, non-canonical surfaces by dividing the surface into quadrangular fragments. Each fragment is characterized by four sides, and each side is assigned a specific “number of divisions” (n1, n2, n3, n4), which determines how the fragment will be subdivided. The configuration of these division numbers dictates the shape of the resulting mesh elements: square elements emerge if all sides have equal divisions (n1=n2=n3=n4), rectangular elements form when opposite sides share equal divisions (n1=n3 and n2=n4), and quadrangular elements are created when all sides have differing divisions. If the total number of divisions across the fragment is odd, a triangular element is introduced to complete the mesh. The system 200 incorporates a technique designed to ensure that neighbouring mesh elements maintain comparable areas and configurations. This comparability is crucial for maintaining structural consistency and ensuring the mesh accurately represents the underlying geometry. The method also ensures continuity at the conjunctions between fragments, eliminating gaps or misalignments in the mesh structure. By applying advanced approximation techniques—linear, quadratic, or cubic—the technique can more accurately capture the intricate geometry of each fragment and the surface as a whole. One of the key strengths of the system 200 lies in its ability to effectively mesh complex and irregular surfaces while preserving structural integrity and precision. By adapting the division numbers and employing flexible geometric approximations, the technique produces meshes that are not only well-ordered but also optimized for practical applications such as numerical simulations or visual modelling. This adaptability ensures that the mesh remains structurally sound and suitable for a wide range of uses, including boundary and finite element methods. In summary, the system 200 offers a robust solution for generating geometric meshes on non-standard surfaces. By combining quadrangular elements, adaptable division patterns, and precise approximation techniques, it ensures high accuracy, consistency, and continuity in the resulting mesh. This innovative approach enhances the ability to tackle complex geometric challenges while maintaining the quality and reliability of the mesh structure.

In some exemplary embodiments of the present disclosure, in an engineering project where an architect designs a non-canonical, curved facade for a new museum. To achieve a balance between aesthetic appeal and structural precision while ensuring effective load distribution, the system 200 generates a detailed geometric mesh. The process begins with partitioning the three-dimensional curved façade into quadrangular fragments based on its geometry. The system 200 assigns specific division numbers to each fragment (e.g., n1=8, n2=6, n3=10, n4=7), determining how each fragment is subdivided into mesh elements. These division numbers guide the formation of different element types: square elements result when all sides have equal divisions, rectangular elements form when opposite sides are equal, and quadrangular elements emerge when all sides differ. To maintain consistency, the system 200 adds a triangular element if the sum of division numbers is odd. Using form functions, the system 200 transforms each fragment into a topological square, ensuring accurate mapping and preserving continuity for further subdivision. The system 200 ensures that the generated mesh elements are comparable in area, configuration, and size, which is crucial for maintaining uniform load distribution and structural integrity. Moreover, the system 200 guarantees seamless transitions at the boundaries of adjacent fragments, preventing gaps or overlaps that could compromise the mesh's structural and aesthetic reliability. To enhance precision, the system 200 applies advanced approximation techniques-linear, quadratic, or cubic-to represent the façade's complex curves more accurately. These approximations allow the mesh to faithfully capture the intricate geometry of each fragment and the entire surface. By leveraging this structured approach, the system 200 produces a well-ordered, structurally sound, and visually harmonious mesh, meeting the engineering and aesthetic requirements of modern architectural projects.

In some other exemplary embodiments of the present disclosure, the system 100 ensures the quality of the generated mesh by maintaining comparable properties among neighbouring elements, including their areas, configurations, and sizes. This uniformity is essential for achieving a consistent and reliable mesh structure. Additionally, the system 100 guarantees continuity at the conjunctions of adjacent fragments, ensuring smooth transitions and seamless integration across the entire surface. To achieve precise geometry representation, the system 100 employs advanced approximation techniques such as linear, quadratic, or cubic methods. These techniques enable the system 100 to accurately capture the geometry of each fragment while preserving the intricate details of the entire non-canonical surface. By doing so, the system 100 generates a mesh that is both geometrically faithful and computationally efficient. Furthermore, the system 100 dynamically adapts to varying relationships between the division numbers assigned to the quadrangular fragments. Whether the numbers are equal on all sides, equal on opposite sides, or different across all sides, the system 100 ensures that the resulting mesh elements-squares, rectangles, quadrangles, or a combination of quadrangles and a triangular element-are formed in accordance with the specified conditions. Thus, the system 100 is versatile in handling a wide range of surface geometries. In summary, the system 100 combines advanced subdivision techniques, continuity enforcement, and high-fidelity approximations to produce well-ordered, accurate meshes for complex non-canonical surfaces. Its capability to manage diverse surface types and ensure uniformity across the mesh makes the system 100 a robust solution for mesh generation challenges.

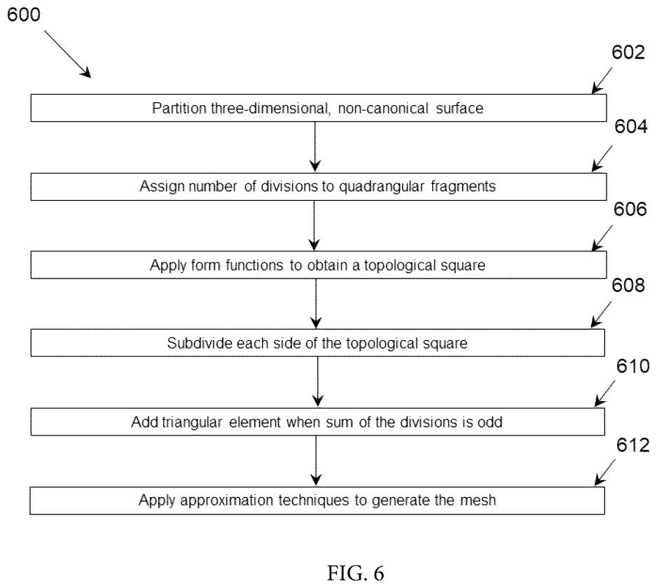

FIG. 6 illustrates a flowchart of a method 600 for generating two-or three-dimensional geometric meshes, in accordance with an embodiment of the present disclosure. The method 600 may include following steps for generating the two-or three-dimensional geometric meshes.

At step 602, the system 200 may be configured to partition the three-dimensional, non-canonical surface. Specifically, the system 200 may be configured to partition the three-dimensional, non-canonical surface into a plurality of quadrangular fragments.

At step 604, the system 200 may be configured to assign the number of divisions (n1, n2, n3, n4) to each side of the quadrangular fragments. The number of divisions determines the subdivision of the corresponding quadrangular fragment.

At step 606, the system 200 may be configured to apply form functions to convert each quadrangular fragment into a topological square.

At step 608, the system 200 may be configured to subdivide each side of the topological square according to the assigned number of divisions. This results in mesh elements that vary in form. The system 200 may be configured to generate square elements when n1, n2, n3, and n4 may be equal to each other. The system 200 may be configured to generate rectangular elements when any two of, n1, n2, n3, and n4 are equal to each other. The system 200 may be configured to generate the quadrangular elements when n1, n2, n3, and n4 are different from each other.

At step 610, the system 200 may be configured to add the triangular element when sum of the divisions is odd.

At step 612, the system 200 may be configured to apply approximation techniques. The approximation techniques may include linear, quadratic, or cubic, that may correspond to geometry of each fragment and the entire surface.

In some embodiments of the present disclosure, comparability property between mesh elements may be achieved without multiple iterations of the mesh generation process. The mesh generation may ensure convexity and order of the quadrangular elements across the entire mesh. The mesh may be formed in the numerical methods, such as, Boundary Elements Method (BEM) technique or Finite Elements Method (FEM) technique to enhance precision and stability.

Thus, the system 200 advantageously facilitates generating a mesh that supports precise calculations in structural analysis software, such as Finite Element Method (FEM) or Boundary Element Method (BEM). By ensuring high precision while minimizing the need for extensive computational iterations, the system 200 proves particularly advantageous for large-scale projects. It enables the creation of designs that are structurally sound and visually appealing, achieving a balance between engineering functionality and aesthetic goals. The system 200 demonstrates its practicality by enhancing the design and analysis of complex surfaces in real-world applications. The system 200 provides a reliable solution for tackling intricate geometries, ensuring efficiency and accuracy while addressing the demands of modern engineering and architectural projects.

In some embodiments of the present disclosure, comparability property between mesh elements may be achieved without multiple iterations of the mesh generation process. The mesh generation may ensure convexity and order of the quadrangular elements across the entire mesh. The mesh may be formed in the numerical methods, such as, Boundary Elements Method (BEM) technique or Finite Elements Method (FEM) technique to enhance precision and stability.

Thus, the system 100 advantageously facilitates generating a mesh that supports precise calculations in structural analysis software, such as Finite Element Method (FEM) or Boundary Element Method (BEM). By ensuring high precision while minimizing the need for extensive computational iterations, the system 100 proves particularly advantageous for large-scale projects. It enables the creation of designs that are structurally sound and visually appealing, achieving a balance between engineering functionality and aesthetic goals. The system 100 demonstrates its practicality by enhancing the design and analysis of complex surfaces in real-world applications. The system 100 provides a reliable solution for tackling intricate geometries, ensuring efficiency and accuracy while addressing the demands of modern engineering and architectural projects.

In an exemplary working of the present invention, the present invention is considered for ggenerating a 3D Mesh for a curved, non-canonical surface. Assume the surface to be meshed is an irregular, wavy surface such as an undulating terrain with variable smoothness.

### Step-by-Step Implementation:

### 8. Partitioning (602):

Input: A 3D model of the wavy surface.
Process: The surface is divided into a grid of quadrangular fragments using surface segmentation techniques. This can be done using algorithms like quad-tree subdivision or curvature-based segmentation.
Output: A set of quadrangular fragments covering the entire surface.

### 9. Assigning Divisions (604):

Input: Each side of the quadrangular fragments.
Process: Assign division counts n1, n2, n3, and n4 to each side based on local surface curvature or the level of detail required. For instance:
   For a fragment with slight curvature: n1=n2=n3=n4 (square elements).
   For a more complex fragment: n1≠n2≠n3≠n4 (quadrangular elements).
Output: Division numbers are set for each side of the fragment.

### 10. Applying Form Functions (606):

Input: Quadrangular fragments and assigned division counts.
Process: Map each quadrangular fragment to a topological square using form functions such as linear, quadratic, cubical mappings to maintain the surface's shape.
Output: Topological squares representing each fragment.

### 11. Subdividing (608):

Input: Topological squares and division counts n1, n2, n3, n4.
Process:
   Subdivide the topological square according to the assigned divisions.
   Resulting elements:
      If n1=n2=n3=n4, the result is square mesh elements.
      If two of n1=n3, and n2=n4, the result is rectangular elements.
      If n1, n2, n3, n4 are all different, the result is quadrangular elements.
Output: Mesh elements of varying forms.

### 12. Adding Triangular Element (610):

Input: Division counts for each fragment.
Process: Check if the sum of the division counts is odd. If so, add a triangular element to balance the mesh. 0
Output: Mesh with additional triangular element if necessary.

### 13. Generating Mesh (612):

Input: Subdivided fragments.
Process: Ensure the mesh is constructed such that adjacent elements have comparable areas, configurations, and sizes. This is a part of algorithm, and does not need using any type of optimization.
Output: A mesh composed of convex quadrangular (and potentially triangular) elements.

### 14. Applying Approximation Techniques:

Input: The generated mesh and its geometric features.
Process:
   Apply linear approximation for flat regions or for oblique planes.
   Use quadratic or cubic approximation for regions with higher curvature to better represent the surface.
Output: A mesh that accurately approximates the geometry of the original surface. BEM or FEM Usage: The mesh is now employed in numerical simulations. For instance, it can be input into FEM software for structural analysis or BEM for potential flow analysis. The high-quality, convex quadrangular mesh ensures more accurate simulation results with better convergence properties.

The described method can handle surfaces with varied smoothness:

For non-smooth surfaces (e.g., surfaces with creases or sharp changes), the form functions and subdivision logic adapt to accommodate these irregularities.

For non-canonical surfaces (e.g., surfaces not following simple geometric definitions), the method still produces a structured, continuous mesh through the partitioning and continuity steps.

Implementing the claims outlined in a real-world context involves several practical steps and considerations, from software development to algorithm optimization. Below is an elaboration on how these claims could be realized in real-world applications:

### 1. Software Development Frameworks and Tools

Programming Languages and Libraries: Use languages like Python, C++, or MATLAB, which are well-suited for computational geometry. Libraries such as CGAL (Computational Geometry Algorithms Library) or OpenMesh can be leveraged for mesh generation and manipulation.
3D Modeling Software: Tools like Blender, Rhino, or Autodesk Maya can integrate custom scripts or plugins that implement the described mesh generation methods.
CAD/CAE Software Integration: For use in engineering applications, plugins or extensions for software like ANSYS, COMSOL, or Abaqus can be developed to incorporate the mesh generation method.

### 2. Partitioning the Surface (Step 602)

Surface Segmentation Algorithms: Implement algorithms that analyze the input 3D surface and segment it into quadrangular fragments. Techniques such as curvature-based partitioning or mesh simplification can identify areas that require higher detail.
Real-world Example: In automotive design, a complex car body can be partitioned into manageable mesh segments for aerodynamic simulation.
Region Growing Algorithm: This algorithm can segment a surface based on criteria such as curvature or normal vector similarity, which helps in dividing a complex surface into quadrangular fragments.
K-Means Clustering: Used to cluster points on the surface into quadrants by treating each surface point as data and grouping based on proximity and curvature.
Example: For automotive design, using the region growing algorithm can help identify and segment parts of a car body where detailed aerodynamic analysis is required.

### 3. Assigning Divisions (Step 604)

Adaptive Division Assignment: Use algorithms that adapt the number of divisions n1, n2, n3, n4 based on surface features, such as curvature analysis. For example, highly curved areas may need higher division counts for better resolution.
Practical Implementation: This can be achieved through gradient-based analysis, where areas with significant changes in surface orientation are assigned more subdivisions.
Example: In structural analysis of bridges, areas near joints or supports may be assigned more subdivisions for detailed analysis.
Adaptive Subdivision Algorithm: Assigns subdivisions dynamically based on surface curvature. Areas with higher curvature get higher n1, n2, n3, n4 values.
Laplacian Smoothing: Ensures that subdivisions adapt smoothly along edges and corners to avoid abrupt changes.
Example: When modelling a turbine blade, adaptive subdivision can ensure finer mesh details near the blade's tip, where more analysis precision is needed.

### 4. Form Functions for Topological Mapping (Step 606)

Mathematical Transformations: Implement form functions using mappings like linear, quadratic, or cubical transformations to convert quadrangular fragments into topological squares.
Computational Strategy: Utilize transformation matrices that maintain the original surface's shape while allowing for easier subdivision.
Example Use Case: Mapping the hull of a ship into topological squares for fluid dynamics simulations.
Linear Interpolation: Used for basic mapping of quadrangular fragments to topological squares.
Quadratic and cubical Interpolation: For smoother transitions, those methods can map a curved quadrangular fragment to a square while preserving the original surface's detail.
Example: In terrain modelling for video games, Quadratic and cubical interpolation ensures smoother rendering when converting uneven terrain fragments to grid structures.

### 5. Subdividing Topological Squares (Step 608)

Mesh Subdivision Techniques: Develop algorithms that subdivide the squares according to the assigned number of divisions. Implement these techniques to generate square, rectangular, or quadrangular elements based on division counts.
Real-world Application: In Finite Elements Method (FEM) or Boundary Elements Method (BEM) of buildings, subdividing mesh squares helps create a grid that can accurately represent areas of stress concentration.
Catmull-Clark Subdivision: Generates refined meshes from coarse ones, creating smooth, subdivided surfaces from topological squares.
Loop Subdivision: Works well for surfaces with quadrangular elements; useful for ensuring subdivisions meet mesh requirements when corners or vertex points are involved.
Example: In medical imaging, Catmull-Clark can subdivide organ models to create smoother, more detailed representations.

### 6. Adding Triangular Element (Step 610)

Conditional Triangle Addition: Write conditional code that checks if the sum of the assigned divisions is odd and adds a triangular element accordingly.
Practical Example: In medical imaging, when generating a mesh for modelling an organ, adding triangular elements helps maintain a uniform mesh where full quadrangular division is not possible.
Delaunay Triangulation: Adds triangle by maximizing the minimum angle between points, ensuring well-shaped, non-degenerate triangle.

### 9. Applying Approximation Techniques

Approach: Implement linear, quadratic, or cubic approximation techniques tailored to each mesh fragment. Quadratic and cubic approximations are ideal for regions with more curvature, while linear approximations can be used for flatter areas.
Real-world Example: In computational fluid dynamics (CFD) for HVAC systems, applying different approximation techniques to various regions helps optimize airflow simulations.
Least Squares Fitting: Fits mesh nodes to a defined curve or surface using a linear, quadratic, or cubic function to approximate the surface accurately.
Bezier Surface Approximation: Uses Bezier curves, or any other spline curve for quadratic or cubic approximation of surfaces that require smooth transitions.
Example: In CFD for HVAC duct design, applying quadratic or cubic approximation improves airflow modelling by approximating curved duct walls.

### Application in Numerical Methods (Claim 2)

Integration with BEM/FEM: The mesh can be directly imported into numerical analysis tools. Scripts or pre-processors can be developed to convert the mesh format into compatible input for FEM (Finite Elements Method) or BEM (Boundary Elements Method) software.
Practical Scenario: In structural analysis of oil rigs, the generated mesh can be used in FEM or BEM to study stress distribution under harsh environmental conditions.
Finite Element Mesh Generation Algorithm: Converts the generated mesh into FEM-compatible format for simulations.
Boundary Element Method Solvers: Directly use the mesh for BEM, where the accuracy of the generated mesh impacts results significantly.
Example: Analyzing vibration modes in mechanical structures like bridges using FEM or BEM software where the mesh from the described method is essential.

### Handling Varied Surface Smoothness (Claim 3)

Algorithmic Adaptability: The method should incorporate algorithms capable of handling non-smooth or non-canonical surfaces by dynamically adapting the mesh density and continuity techniques.
Implementation Toolkits: Use robust software platforms that handle non-manifold geometry and irregular surface topologies.
Practical Example: In computer graphics, creating meshes for virtual reality (VR) applications where highly detailed, non-canonical surfaces need accurate representation.
Multiresolution Mesh Analysis: Allows the mesh to adapt to different levels of smoothness by coarsening or refining based on local surface characteristics.
Example: In 3D scanning and reverse engineering, adaptive refinement helps mesh objects that have both smooth and rough surfaces, like archaeological artefacts.

Real-world implementation of this mesh generation method involves a blend of computational geometry, optimization techniques, and software development. The described method ensures practical applicability across various engineering, medical, and visualization fields. Leveraging advanced algorithms and software tools, this approach can significantly improve the efficiency and accuracy of numerical simulations and modelling tasks.

Implementing the described method involves leveraging established algorithms and computational techniques to create robust, high-quality geometric meshes for real-world engineering, scientific, and graphical applications. Using proposed algorithm ensures that the method is capable of handling complex geometries and diverse surface characteristics, making it suitable for applications ranging from mechanical simulations to digital twin modeling.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

I claim:

1. A method for generating two-or three-dimensional geometric meshes, the method comprising:
partitioning a three-dimensional, non-canonical surface into a plurality of quadrangular fragments;
assigning a number of divisions (n1, n2, n3, n4) to each side of the quadrangular fragments, wherein the number of divisions determines the subdivision of the corresponding quadrangular fragment;
applying form functions to convert each quadrangular fragment into a topological square;
subdividing each side of the topological square according to the assigned number of divisions, resulting in mesh elements that vary in form, wherein square elements when n1, n2, n3, and n4 are equal to each other, rectangular elements when any two of, n1, n2, n3, and n4 are equal to each other, and quadrangular elements when n1, n2, n3, and n4 are different from each other;
adding a triangular element when sum of the divisions is odd;
applying approximation techniques comprising linear, quadratic, or cubic, that corresponds to geometry of each fragment and the entire surface.

2. The method of claim 1, further comprising employing the mesh in numerical methods, wherein the numerical methods comprising one of, Boundary Elements Method (BEM) and Finite Elements Method (FEM).

3. The method of claim 1, wherein the mesh is applicable to surfaces with varied smoothness, wherein the surfaces comprising one of, non-smooth surfaces and non-canonical surfaces.

4. A system to generate ordered quadrangular meshes for three-dimensional, non-canonical surfaces, the system comprising:
a partitioning unit configured to partition an input surface into quadrangular fragments;
a computational unit coupled to the partitioning unit, and configured to transform each fragment into a topological square using form functions;
a subdivision module coupled to the computational unit, and configured to assign and apply different numbers of divisions (n1, n2, n3, and n4) to each side of the square, that results in various mesh forms comprising square, rectangular, and quadrangular elements; and
a mesh generation unit coupled to the subdivision module, and configured to construct an ordered mesh with convex quadrangular elements, wherein the neighbouring elements have comparable properties, wherein a triangular element is added when sum of the divisions is odd.

5. The system of claim 3, further comprising an output unit coupled to the mesh generation unit, and configured to display the mesh that is generated by the mesh generation unit.

6. The system of claim 3, wherein the mesh generation unit employs a mesh generation technique that facilitates construction of the ordered mesh as an integral part in generation of the mesh.

7. The system of claim 5, wherein the mesh generation technique employs linear, quadratic, or cubic approximations that corresponds to geometry of each mesh fragment and the entire mesh.

8. The system of claim 6, wherein the mesh generation unit is configured to reconstruct each mesh fragment from the topological square to an original form by way of reconversions of the form functions.

9. The system of claim 3, wherein the mesh is applicable to surfaces with varied smoothness, wherein the surfaces comprising one of, non-smooth surfaces and non-canonical surfaces.

10. A computer program product, stored on a non-transitory computer-readable medium, comprising instructions that, when executed by a processor, perform the steps of:
partitioning a three-dimensional, non-canonical surface into a plurality of quadrangular fragments;
assigning a number of divisions (n1, n2, n3, n4) to each side of the quadrangular fragments, wherein the number of divisions determines the subdivision of the corresponding quadrangular fragment;
applying form functions to convert each quadrangular fragment into a topological square;
subdividing each side of the topological square according to the assigned number of divisions, resulting in mesh elements that vary in form, wherein square elements when n1, n2, n3, and n4 are equal to each other, rectangular elements when any two of, n1, n2, n3, and n4 are equal to each other, and quadrangular elements when n1, n2, n3, and n4 are different from each other;
adding a triangular element when sum of the divisions is odd;
generating a mesh comprising convex quadrangular elements such that adjacent elements are comparable in area, configuration, and size;
ensuring continuity at the conjunctions between adjacent fragments;
applying approximation techniques comprising linear, quadratic, or cubic, that corresponds to geometry of each fragment and the entire surface.
